(19) United States
(12) Patent Application Publication
(10) Pub. No.: US 2011/0162034 A1
(43) Pub. Date: Jun. 30, 2011

(54) DISCOVERY AND MANAGEMENT OF CONTEXT-BASED ENTITLEMENTS ACROSS LOOSELY-COUPLED ENVIRONMENTS

(75) Inventors: NATARAJ NAGARATNAM, Morrisville, NC (US); Anthony Joseph Nadalin, Austin, TX (US)

(73) Assignee: International Business Machines Corporation, Armonk, NY (US)

(21) Appl. No.: 12/649,421

(22) Filed: Dec. 30, 2009

(51) Int. Cl. H04L 9/32; G06F 21/22

(52) U.S. Cl. 726/1; 726/4

(57) ABSTRACT

A method, apparatus and computer program product are provided to model and manage context-based entitlements that govern a user's access to information, applications and systems across a loosely-coupled distributed environment. One such distributed environment is a federated environment, which may span across companies, organizations, and geographical locations and regions. According to one embodiment, an entitlement modeling framework comprises a discovery module and an entitlement generator module. The discovery framework generates a data model for storing information concerning user identity, context, relationships between users, relationships between users and contexts and relationships between contexts. Preferably, the user identity, context, relationships between users, relationships between users and contexts, and relationships between contexts, are stored as attributes in the data model. An entitlement generator generates an entitlement according to the data model, wherein the entitlement (e.g., a user entitlement) is generated according to one or more contexts.

### BACKGROUND OF THE INVENTION

1. Technical Field

This disclosure relates generally to discovery and generation of user entitlements in a loosely-coupled distributed computing environment.

2. Background of the Related Art

Role-based access control (RBAC) for enforcing security within an enterprise is well-known in the prior art. Typically, a role is a set of permissions that are enabled for an organizational agent that performs certain job functions. Role engineering is the process of defining a set of roles for the organization and assigned permissions to those roles. Role engineering may be carried out in a top-down manner, or a bottom-up manner. In a top-down approach, roles are defined by analyzing business processes and identifying the one or more functions that comprise each such process; a set of permissions on information systems are then associated with each function. Typically, the top-down approach begins by defining a job function; a role is then created for this function by associating whatever permissions are needed. Role mining can be used in conjunction with this top-down approach to identify proposed roles that can be examined to determine if that satisfy the business process function to which they might be associated. In contrast, in a bottom-up approach, existing permission assignments are used to formulate roles. Typically, one or more permission assignments are aggregated and associated with a role, and the process may be automated for efficiency.

A typical RBAC model is based on role names, and assignment of users to those roles. The associated access control is based on these roles. An RBAC-based role typically has meaning only within a given context (i.e., within a Company in which the role is defined, with respect to a given application system used in the Company, or the like). Moreover, role-based access control usually requires centralized management of user-to-role and permission-to-role assignments and, as a consequence, it is not well-suited for distributed environments, such as a federation. As is known in the art, a federated environment is a loosely-coupled set of distinct entities, such as enterprises, organizations, institutions or the like, that cooperate to provide a single sign-on, ease-of-use experience to a user. This type of environment often involves distinct security domains. RBAC and other known security techniques do not work well across such distinct domains. Also, role-based approaches may not be scalable in such federated environments, as one may end up with more roles than are manageable. Moreover, discovery of existing security configurations across loosely-coupled environments is very difficult.

There are other types of known access control techniques, and it is also known that access control systems often use “data models” to define information and relationships among security-related components and users. Data models describe how enterprise-related data, permissions and the like are managed so that data can be retrieved and processed efficiently. Although these approaches often work well within their defined use environments for configuration and service metadata, they are not applied for managing entitlements and security across loosely-coupled environments, such as a federated environment.

### BRIEF SUMMARY

A method and apparatus are provided to model and manage context-based entitlements that govern a user's access to information, applications and systems across a loosely-coupled distributed environment. One such distributed environment is a federated environment, which may span across companies, organizations, social networks, and geographical locations and regions.

The techniques described herein are used to create a core data model around the notion of context, entities and relationships. As used herein, a “context” refers to a logical scope within which information and access about an identity is relevant and applicable. An “identity” defines a set of characteristics (which, in turn, are defined by a set of attributes and related information) that represent various views of an entity within a given context. Examples of “identity” include, without limitation, entities such as user, group, role, organization, application (that runs under a given identity), and the like. As used herein, a “user” may also be considered generic to an identity, as defined above. Thus, an identity may be used to scope a user in a given context, to define the access given to an identity within that context, to define a role within a context, and the like. Entitlements are a set of control specifications (preferably rendered through policies) that govern an identity's access to information, application and systems, where a user is one such identity. Preferably, entitlements are generated based on relationships between entities within or across contexts, and one such relationship is a hierarchy. In one embodiment, information within existing business or information technology (IT) systems is discovered and mapped to generate a view of user entitlements in a given environment.

An entitlement reflects the responsibilities and relationships that an individual may have and his or her assigned privileges, all within a given context. The disclosed system provides for more fine-grained access control decisions that are context-based, preferably within a loosely-coupled distributed environment.

According to one embodiment, an entitlement modeling framework comprises a discovery module and an entitlement generator module. The discovery framework generates a data model for storing information concerning user identity, context, relationships between users, relationships between users and contexts and relationships between contexts. Preferably, the user identity, context, relationships between users, relationships between users and contexts, and relationships between contexts, are stored as attributes in the data model. An entitlement generator generates an entitlement according to the data model, wherein the entitlement (e.g., a user entitlement) is generated according to one or more contexts. Also, the user entitlement may be generated according to a role (which may be based on a cluster of users who share a set of permissions and thus are identified according to that role), a user attribute, a relationship of a role to a context, a relationship between a user and another user, or the like.

According to another embodiment, a computer program product is provided for use in a data processing system for entitlement management and processing. The product holds computer program instructions which, when executed by the data processing system, generate and store a data model that associates one or more identities to an entity. Preferably, each identity in the data model has an associated set of characteristics that represent a view of the entity within a context. The program instructions also enable the data model to generate at least one entitlement, wherein the entitlement governs an identity's access to information, applications and systems.

The foregoing has outlined some of the more pertinent features of the invention. These features should be construed to be merely illustrative. Many other beneficial results can be attained by applying the disclosed invention in a different manner or by modifying the invention as will be described.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 depicts an exemplary block diagram of a distributed data processing environment in which exemplary aspects of the illustrative embodiments may be implemented;

FIG. 2 is an exemplary block diagram of a data processing system in which exemplary aspects of the illustrative embodiments may be implemented;

FIG. 3 is an exemplary block diagram of a federated or “loosely-coupled” distributed environment in which the subject disclosure may be implemented;

FIG. 4 is a UML-based data model according to the teachings herein;

FIG. 5 illustrates how a set of users, roles and entitlements can depend on context;

FIG. 6 illustrates how to build on an existing data model of contexts and relationships with respect to a given set of users to thereby accommodate a notion of organizational and application privileges according to the techniques herein; and

FIG. 7 is an entitlement modeling and discovery framework according to the present invention;

### DETAILED DESCRIPTION OF AN ILLUSTRATIVE EMBODIMENT

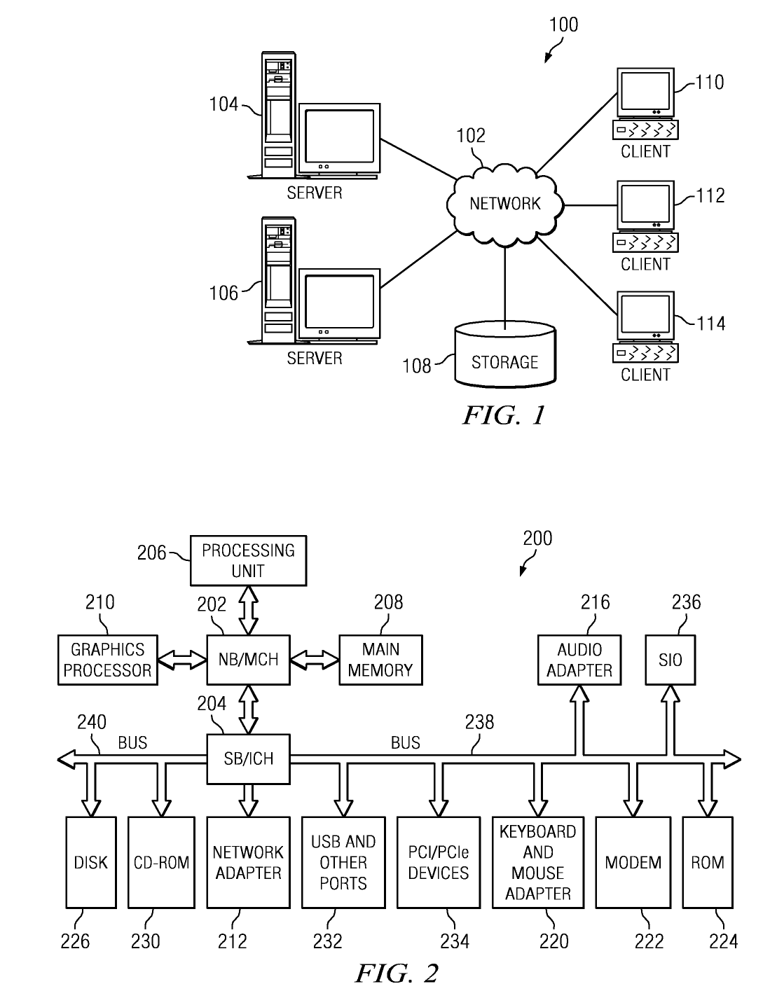

With reference now to the drawings and in particular with reference to FIGS. 1-2, exemplary diagrams of data processing environments are provided in which illustrative embodiments of the disclosure may be implemented. It should be appreciated that FIGS. 1-2 are only exemplary and are not intended to assert or imply any limitation with regard to the environments in which aspects or embodiments of the disclosed subject matter may be implemented. Many modifications to the depicted environments may be made without departing from the spirit and scope of the present invention.

With reference now to the drawings, FIG. 1 depicts a pictorial representation of an exemplary distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the disclosed subject matter, and therefore, the particular elements shown in FIG. 1 should not be considered limiting with regard to the environments in which the illustrative embodiments of the present invention may be implemented.

With reference now to FIG. 2, a block diagram of an exemplary data processing system is shown in which aspects of the illustrative embodiments may be implemented. Data processing system 200 is an example of a computer, such as client 110 in FIG. 1, in which computer usable code or instructions implementing the processes for illustrative embodiments of the disclosure may be located.

In the depicted example, data processing system 200 employs a hub architecture including bridge and memory controller hub (NB/MCH) 202 and bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java is a trademark of Sun Microsystems, Inc. in the United States, other countries, or both).

As a server, data processing system 200 may be, for example, an IBM® eServer™ System p® computer system, running the Advanced Interactive Executive (AIX®) operating system or the LINUX® operating system (eServer, System p, and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the disclosure may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system, other than the SMP system mentioned previously, without departing from the spirit and scope of the disclosed subject matter.

A “loosely-coupled” distributed processing environment, sometimes referred to as a “federated environment,” also is well-known in the prior art. In one particular embodiment, as will be described in more detail below, the subject invention is implemented within one such loosely-coupled environment, although this is not a limitation of the invention.

By way of additional background, a federation is a set of distinct entities, such as enterprises, logical units within an enterprise, organizations, institutions, etc., that cooperate to provide a single-sign-on, ease-of-use experience to a user; a federated environment differs from a typical single-sign-on environment in that two enterprises need not have a direct, pre-established, relationship defining how and what information to transfer about a user. Within a federated environment, entities provide services which deal with authenticating users, accepting authentication assertions that are presented by other entities, and providing some form of translation of the identity of the vouched-for user into one that is understood within the local entity. Federation eases the administrative burden on service providers. A service provider can rely on its trust relationships with respect to the federation as a whole. The service provider does not need to manage authentication information, such as user password information, because it can rely on authentication that is accomplished by a user's authentication home domain or an identity provider. In a typical federated environment, a federated identity management system is provided to establish a foundation in which loosely coupled authentication, user enrollment, user profile management and/or authorization services collaborate across security domains. Federated identity management allows services residing in disparate security domains to securely interoperate and collaborate even though there may be differences in the underlying security mechanisms and operating system platforms at these disparate domains.

A federated environment allows a user to authenticate at a first entity, which may act as an issuing party to issue an authentication assertion about the user for use at a second entity. The user can then access protected resources at a second, distinct entity, termed the relying party, by presenting the authentication assertion that was issued by the first entity without having to explicitly re-authenticate at the second entity. Information that is passed from an issuing party to a relying party is in the form of an assertion, and this assertion may contain different types of information in the form of statements. For example, an assertion may be a statement about the authenticated identity of a user, or it may be a statement about user attribute information that is associated with a particular user. Furthermore, this information can be used by a relying party to provide access to the relying party's resources, based on the relying party's access control rules, identity mapping rules, and possibly some user attributes that are maintained by the relying party.

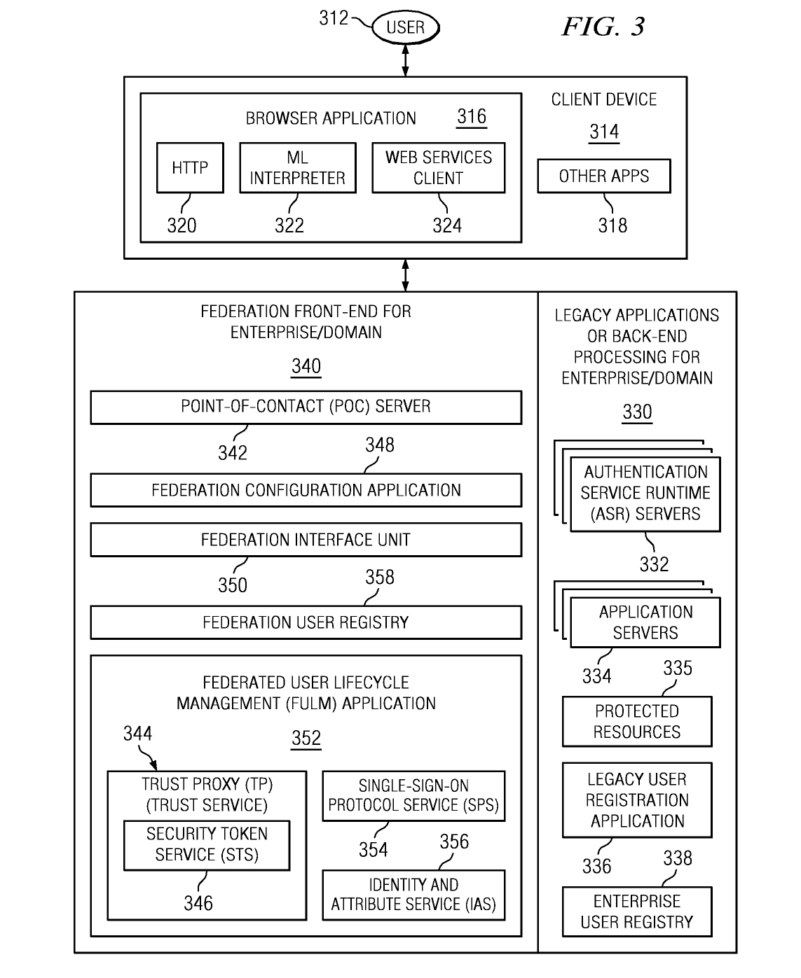

FIG. 3 is a block diagram that depicts the integration of pre-existing data processing systems (such as those described above) at a given domain with some federated architecture components that may be used to support an embodiment of the present invention. As noted above, a federated environment includes federated entities that provide a variety of services for users. User 312 interacts with client device 314, which may support browser application 316 and various other client applications 318. User 312 is distinct from client device 314, browser 316, or any other software that acts as interface between user and other devices and services. In general, a requester is an intermediary, such as a client-based application, browser, SOAP client, or the like, that may be assumed to act on behalf of the user.

Browser application 316 may be a typical browser, including those found on mobile devices, which application comprises many modules, such as HTTP communication component 320 and markup language (ML) interpreter 322. Browser application 316 may also support plug-ins, such as web services client 324, and/or downloadable applets, which may or may not require a virtual machine runtime environment. Web services client 324 may use Simple Object Access Protocol (SOAP), which is a lightweight protocol for defining the exchange of structured and typed information in a decentralized, distributed environment. SOAP is an XML-based protocol that consists of three parts: an envelope that defines a framework for describing what is in a message and how to process it; a set of encoding rules for expressing instances of application-defined data types; and a convention for representing remote procedure calls and responses. User 312 may access web-based services using browser application 316, but user 312 may also access web services through other web service clients on client device 314. Some of the federated operations may employ HTTP redirection via the user's browser to exchange information between entities in a federated environment, although a variety of other communications protocols and techniques may be used. The components that are required for a federated environment can be integrated with pre-existing systems. FIG. 3 depicts one embodiment for implementing these components as a front-end to a pre-existing system, although other approaches may be used. The pre-existing components at a federated domain can be considered as legacy applications or back-end processing components 330, which include authentication service runtime (ASR) servers 332. ASR servers 332 are responsible for authenticating users when the domain controls access to application servers 334, which can be considered to generate, retrieve, or otherwise support or process protected resources 335. The domain may continue to use legacy user registration application 336 to register users for access to application servers 334. Information that is needed to authenticate a registered user with respect to legacy operations is stored in enterprise user registry 338; enterprise user registry 338 may be accessible to federation components as well.

After joining a federated environment, the domain may continue to operate without the intervention of federated components. In other words, the domain may be configured so that users may continue to access particular application servers or other protected resources directly without going through a point-of-contact server or other component implementing this point-of-contact server functionality; a user that accesses a system in this manner would experience typical authentication flows and typical access. In doing so, however, a user that directly accesses the legacy system would not be able to establish a federated session that is known to the domain's point-of-contact server.

The domain's legacy functionality can be integrated into a federated environment through the use of federation front-end processing 340, which includes point-of-contact server 342 and trust proxy server 344 (or more simply, trust proxy 344 or trust service 344) which itself interacts with Security Token Service (STS) 346. Federation configuration application 348 allows an administrative user to configure the federation front-end components to allow them to interface with the legacy back-end components through federation interface unit 350. Federated functionality may be implemented in distinct system components or modules. Most of the functionality for performing federation operations may be implemented by a collection of logical components within a single federation application; thus, for example, federated user lifecycle management application 352 includes trust service 344 along with single-sign-on protocol service (SPS) 354. Trust service 344 may comprise identity-and-attribute service (IAS) 356, which is responsible for identity mapping operations, attribute retrieval, and so forth, as part of federation functionality. Identity-and-attribute service 356 may also be employed by single-sign-on protocol service 354 during single-sign-on operations. A federation user registry 358 may be employed in certain circumstances to maintain user-related information for federation-specific purposes.

Legacy or pre-existing authentication services at a given enterprise may use various, well known, authentication methods or tokens, such as username/password or smart card token-based information. However, in a preferred federated computing system for supporting the present invention, the functionality of a legacy authentication service can be used in a federated environment through the use of point-of-contact servers. Users may continue to access a legacy authentication server directly without going through a point-of-contact server, although a user that accesses a system in this manner would experience typical authentication flows and typical access; a user that directly accesses a legacy authentication system would not be able to generate a federated authentication assertion as proof of identity in accordance with the present invention. One of the roles of the federation front-end is to translate a federated authentication token received at a point-of-contact server into a format understood by a legacy authentication service. Hence, a user accessing the federated environment via the point-of-contact server would not necessarily be required to re-authenticate to the legacy authentication service. Preferably, the user would be authenticated to a legacy authentication service by a combination of the point-of-contact server and a trust proxy such that it appears as if the user was engaged in an authentication dialog.

With the above as background, the techniques of this disclosure can now be described in more detail.

As noted above, the techniques described herein are used to create a core data model around the notion of context, entities and relationships. As used herein, a “context” refers to a logical scope within which information and access about an identity is relevant and applicable. An “identity” defines a set of characteristics (which, in turn, are defined by a set of attributes and related information) that represent various views of an entity within a given context. Thus, an identity may be used to scope a user in a given context, to define the access given to an identity within that context, to define a role within a context, and the like. Entitlements are a set of control specifications (preferably rendered through policies) that govern an identity's access to information, application and systems, where a user is one such identity. Preferably, entitlements are generated based on relationships between entities within or across contexts, and one such relationship is a hierarchy. In one embodiment, information within existing business or information technology (IT) systems is discovered and mapped to generate a view of user entitlements in a given environment. An entitlement reflects the responsibilities and relationships that an individual may have and his or her assigned privileges, all within a given context. As will be described, the disclosed system provides for more fine-grained access control decisions that are context-based, preferably within a loosely-coupled distributed environment such as a federation

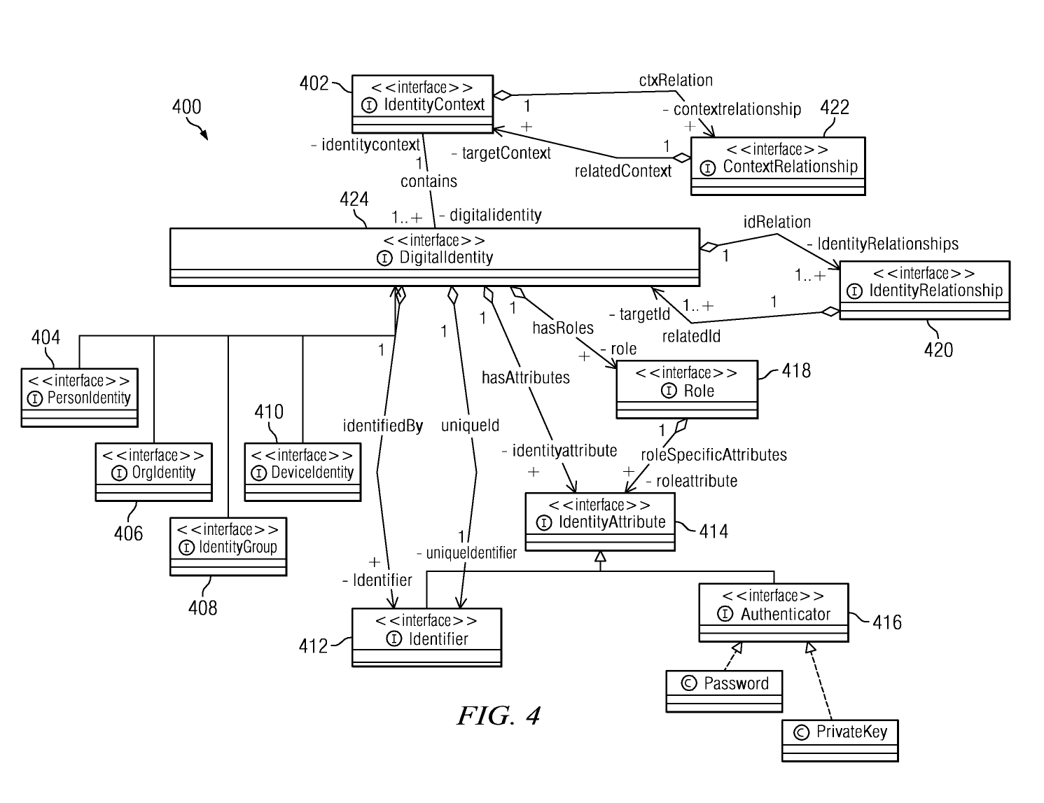

An entity, like a person or organization, has one or more identities in a given context. Thus, an identity defines a set of characteristics (defined by a set of attributes and related information) that represent various views of an entity, within a given context. FIG. 4 is a representative UML-based data model 400 illustrating these concepts. As noted, an entity (a person, an organization, a group, a resource, a device, or the like) has one or more identities in a given context. From the system viewpoint, a given identity is a representation of an entity, and that identity may be related to other identities. Each such identity is illustrated in the data model 400 as an identity context element 402. People, organizations, groups, devices and the like are each entities that will have identities. Their characteristics are captured in the data model as “types” of identities, including a person identity type element 404, an organization identity type element 406, a group identity type element 408, and a device identity type element 410. Identifier elements 412 help identify an identity in a given context. Preferably, an identity has one unique identifier. An identifier has one or more attributes associated therewith, each defined by an identity attribute element 414. An identity also may have multiple authenticators as defined by authenticator elements 416. A given authenticator may only validate some of attributes and not all of them. As also illustrated, an identity can take on zero or more roles, each defined by a role element 418. The scope of the role is relevant to the appropriate context. By taking on a role, an identity may get additional attributes (not shown). These are attributes that are specific to the role, and when the role is removed (e.g., revoked, retired, or the like), then those attributes are no longer relevant to that identity.

As also seen in FIG. 4, the data model 400 typically includes an identity relationship element 420, and a content relationship element 422. The identity relationship element 420 is an element that associates identity and context. The context relationship element 422 defines a relationship between identities. Finally, the data model includes one or more digital identities, where a digital identity element 424 is a set of claims made by one digital subject about itself or another digital subject. A digital subject thus represents a particular instance of an identity that is useful to complete some identity-based transaction, typically with respect to some system, application or resource. In general then, for any given digital subject, there may exist many such digital identity instances.

The following provides examples of the data model, although these examples should not be taken by way of limitation. As noted, an entity, like a person or organization, has one or more identities in a given context, and each identity defines a set of characteristics (defined by a set of attributes and related information) that represent various views of the entity within that context. A human being typically has many identities. Thus, for example, assume Bob Smith as a person has an identity relevant to his employer (e.g., IBM). Bob Smith as an entity has an identity (with his email as identifier—bsmith@us.ibm.com, and with attributes like level, location, and the like), and this identity is relevant to a given context (e.g., IBM Bluepages). Similarly, Bob Smith has an identity as an employee (to his employer), as a citizen (to the government), and so forth, with respect to any person, organization, group or device type. As noted above, an identity has a set of attributes that defines the characteristics of that entity. Some of those attributes are relevant to that identity in a given context (e.g., name, account number, etc), and some are specific to particular roles that the identity may take on in that given context. Some of these attributes may also be shared across different contexts. Thus, for example, Bob Smith may have attributes, such as email-address, phone number, passport information, fingerprint data, or the like that may be shared with others, such as his employer, port control authority, or the like. Bob Smith may have a specific attribute, such as platinumCustomer, and preferredColor, in the context of “customer” to an entity such as Clothes-R-Us. As also noted, an identity can be identified by one or more identifiers, e.g., email id, short name, etc. An identity may have multiple authenticators. A given authenticator may only validate some of the attributes and not all of them (e.g., a password is sufficient to identify a Teller role, but not Supervisor role). Some authenticators may be self-managed identifiers, assigned by a naming authority, or merely system identifiers. Among these, preferably there is one identifier (e.g., X.500 name) that uniquely identifies that identity in a given context. Thus, as noted above, a given identity has at least one attribute that acts as an identifier. For example, Bob Smith may have a “bob” identifier in CompanyA's system, an identifier bsmith@us.ibm.com in his employer's system, an identifier SSN in a Government system, and so forth. Example types of relationships between identities are (a) an entity Bob Smith can have an identity bsmith (as identifier) in IBM and bsmith (as identifier), and those two identities can be related, (b) an organization identity (e.g., SWGOrg) has its employees (person identities), (c) a group identity, USTennisTeam, is related to its constituent players (d) person identity bsmith is related to a device identity cell-phone sim#1234, and so forth. An identity can take on zero or more roles. The scope of a given role is relevant to the appropriate context. By taking on a role, an identity may include additional attributes. e.g., PCP has <patientList, specialty>. A financialAdvisor role may have <certificationLevel, adviseeList>, etc. Such attributes that are specific to a role are typically given values (e.g., specialty is ‘cardiologist’) when the role is assigned to an identity and, thus, the values of those role specific attributes are specific to a given identity. Attributes may also be independent of role, e.g., “location=NewYork,” which in a given use case might apply that users in a primary care physician (PCP) role and in New York would have the privilege to treat patients in that State.

When roles are removed (revoked, retired, etc) from an identity, then as noted above those role-specific attributes are not relevant to that identity, whereas role-independent attributes would still continue to be relevant. In the data model, a user group provides a way to represent a collection of users (also defined within that given context). Nested groups are also possible, where a particular group contains other groups defined within that context. Given that a group has attributes and identifiers (e.g., for articulating access policies), it is a considered a type of identity. It may also refer to other identities using the approach of capturing identity relationships.

Also as discussed above, an entity's identity is relevant to a given context. Such a context can be an enterprise, an organization, or the like. Contexts in these cases can be nested (e.g., organizations within an enterprise has organizations, systems within an enterprise, and so forth), or they may be related through other (indirect) means. Thus, linking one or more identities relevant to one or more contexts provides an overall view of an identity (at least partial to those contexts, although not necessarily global). The data model advantageously maintains a set of one or more relationships among multiple different identities associated with an entity. The set (of relationships, as exemplified by the data model) can be maintained in a single place for a set of contexts; in the alternative, these relationships may be treated as identities, in which case they may be federated within and across contexts, enterprises and organizations. Thus, an entity typically has multiple identities within an enterprise or outside an enterprise. The identities can then be federated to get a unified view of a given entity. In this way, the subject approach facilitates mapping identities across systems and across enterprises to be handled using the same technical approach.

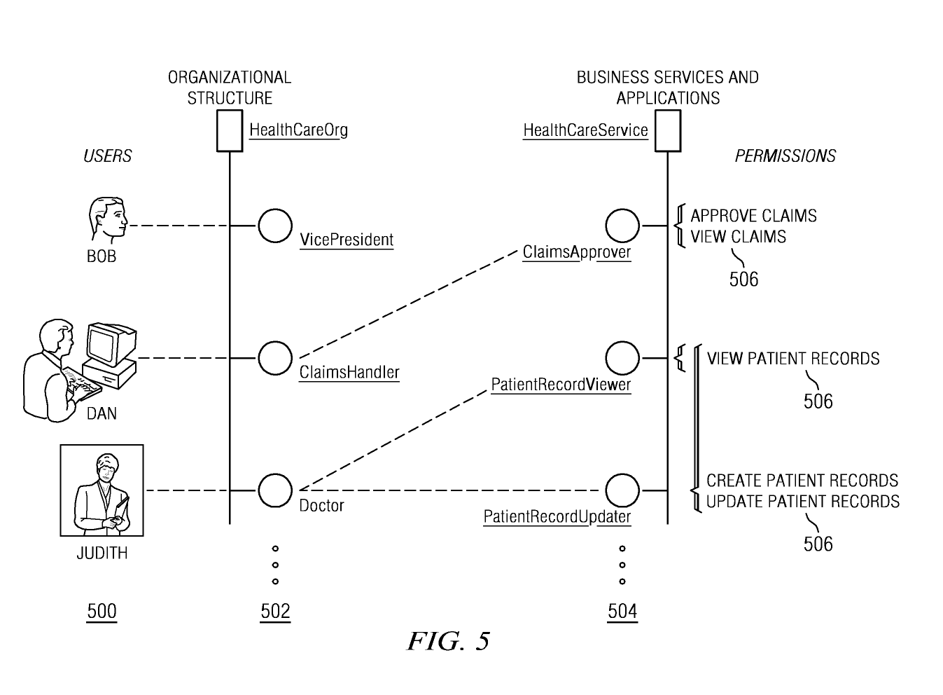

FIG. 5 illustrates how a set of users, roles and application entitlements can depend on context. In this example, a set of users 500 within a defined organizational structure 502 (called Health Care Organization) are to be provided with access to a set of business services and applications 504 (called Health Care Service). The organizational structure is a health care organization with several organizational responsibilities: Vice President (Bob), Claims Handler (Dan), and Doctor (Judith). The Health Care Service (a business service) has several representative applications: ClaimsApprover, PatientRecordViewer, and PatientRecordUpdater. As can be seen in the example, the Claims Handler role in the Health Care Organization is permitted to access and use the ClaimsApprover application in the Health Care Service and, as such, has two (2) permissions (entitlements): approve claims, and view claims. A Doctor role in the Health Care Organization is permitted to access and use a PatientRecordViewer application and a PatientRecordUpdater application in the Health Care Service and, as such, has the following entitlements: view patient records, create patient records, and update patient records. The Doctor role, however, cannot access and use the ClaimsApprover application, and the Claims Handler role cannot access and use either the PatientRecordViewer or PatientRecordUpdater applications. As can be seen, the defined entitlements (the permissions shown on the right portion of the figure) are a set of control specifications (preferably rendered through policies) that govern a user's access to information, applications and systems, in this example, the various applications identified as being associated with the Health Care business service. Thus, according to the teachings herein, a particular entitlement is contextual, and it reflects the responsibilities and relationships a person may have and their assigned privileges. A logical grouping of identifies based on criteria (such as job titles, job codes, or other organizational attributes) is sometimes referred to herein as an organizational responsibility, and this is shown by the grouping 502. An application privilege 506 reflects a set of privileges with respect to that application that a person is entitled to carry out.

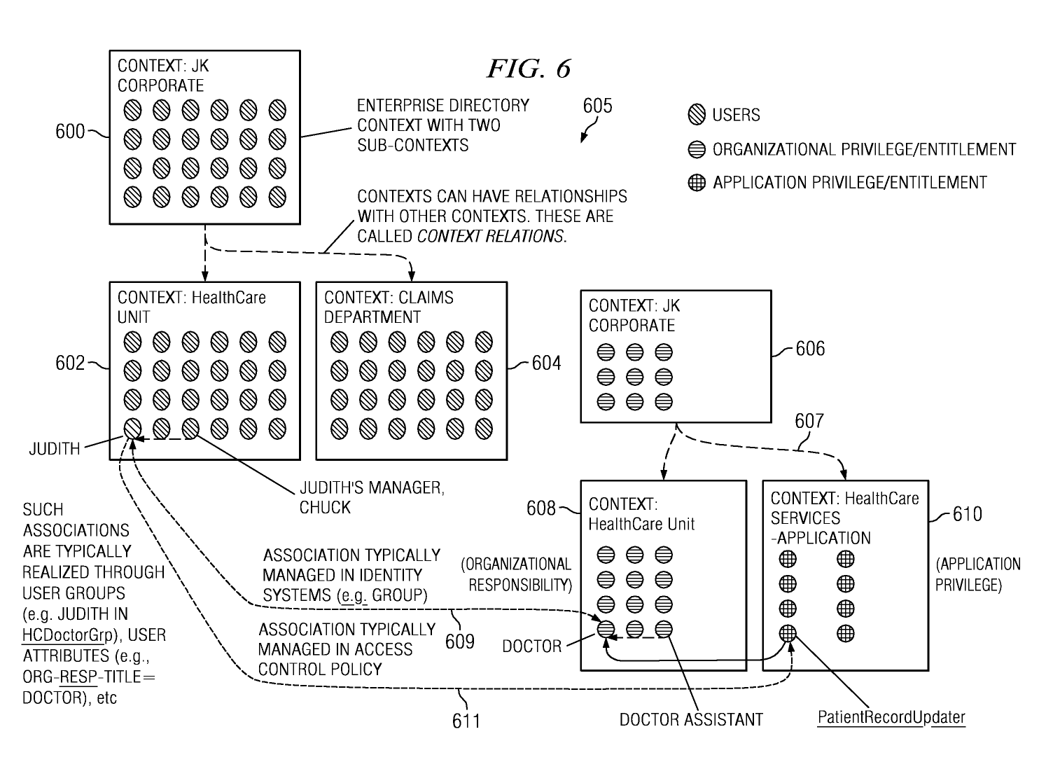

FIG. 6 provides additional details regarding how to model contexts and relationships for the users, roles and applications illustrated in FIG. 5. In this example, it is assumed that there is a set of JK Corporate users 600 that are discovered from an enterprise directory. In this example, this enterprise directory context has two other contexts: a health care unit 602, and a claims department 604. As the arrows 605 indicate, the enterprise directory context 600 has a relationship with each of the other contexts 602 and 604. More generally, contexts can have relationships with other contexts with so-called “context relations.” As also seen, Judith, the doctor in FIG. 5, is associated with the health care unit 602, as is Judith's manager, Chuck. The association of Judith and her manager Chuck is shown by an arrow. More formally, Judith's association with the health care unit may be realized through a user group (e.g., Judith in HCDoctorGrp), and one or more user attributes (e.g., org-resp-title=Doctor). As also seen in FIG. 6, and based on the description above with respect to FIG. 5, this data model includes an organizational responsibility 606 (for JK Corporate) that itself has a related health care unit context 608, as well as a related health care service application context 610. These associations are evidenced by arrows 607. In this health care unit context 608, a role (such as Doctor Assistant) may be associated with another role (such as Doctor). This is indicated by an arrow within the health care unit context. As shown, Judith (as she is defined in the health care unit context 602) may be associated with the Doctor role in the organizational responsibility context in health care unit context 608. This association is reflected by the arrow 609. Likewise, in this example, Judith is associated with the PatientRecordUpdater application in the health care service application context 610. This association is evidenced by arrow 611. This association typically is set forth in an access control policy for that application. As also seen in this example, the PatientRecordUpdater application is associated with a Doctor role in the health care unit context 608.

In this way, the model shown in FIG. 6 illustrates how users, organizational privileges and application privileges are related to one another using the data model. Entitlements are reflected by a set of one or more associations, such as the arrows 609 and 611. More generally, the access and entitlements are a set of control specifications (preferably rendered through policies) that govern an identity's access to information, application and systems, where a user is one such identity. Preferably, and as illustrated in FIG. 6, entitlements are generated based on relationships between entities (e.g., a user to user relationship, a user to resource relationship, a user to data relationship, and so on) within or across contexts. More generally, the abstract data model provides entitlement management (i.e., linking people to resources, across contexts and through relationships, and based on policies and rules) that allows for a set of entitlement definitions to be managed and used within and across environments.

In other words, “context” provides a logical scope within which information and access about an identity is relevant and applicable. It is used to scope a user in a given context (e.g., Bob Smith in CompanyA where CompanyA is context), access given to an identity within that context (e.g., Bob can have access to enterprise information within CompanyA's/FinancialApplication context), definition of a role within a context (e.g., Bob is a VP in CompanyA), and such. As described above, a context may be related to one or more other contexts, and one relationship is a hierarchical relationship (e.g., FinancialApplication context within CompanyA context, HRDepartment context within CompanyA, while CompanyA itsself is a context).

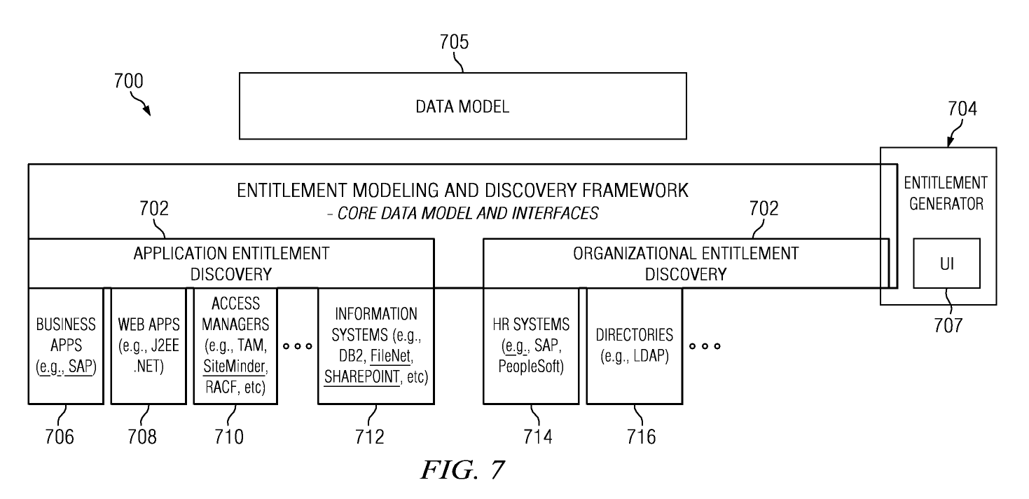

With reference now to FIG. 7, an entitlement modeling framework 700 of this disclosure comprises a discovery module 702, and an entitlement generator module 704. The discovery module 702 preferably performs both application entitlement discovery, as well as organizational entitlement discovery. Application entitlement discovery is carried out by having the framework interface to one or more enterprise systems, including such systems in a loosely-coupled distributed environment, such as business applications 706, Web applications 708, access managers 710 or other information systems 712. Each such enterprise system typically has an associated application programming interface (API) through which application entitlement data can be mined and discovered by the modeling framework. The following is an example of this mining process:

Identity focusIdentity=context.getIdentity( );

List relatedIdentities=focusIdentity.getRelationships(type.Identity), where “relatedIdentities” is a list of identities to which an identity called ‘focusIdentity’ is related. An identity type is specified as type.Identity; if the type is not specified, the API call can return all relationships including relationships to resources, other identities, and the like. Of course, the above example is merely representative of how to mine the entitlement data, and each enterprise system may have a distinct API requirement.

When implemented within a loosely-coupled distributed environment, access to entitlement information may be carried out by existing federated identity management (FIM) systems, which systems allow an authorized entity to access the information and in response return identity information that can be factored into the entitlement modeling framework. In like manner, one or more organizational systems, such as HR systems 714, directory systems 716, and the like, provide APIs to the framework and by which organization entitlements are mined. The particular techniques for obtaining application and/or organizational entitlements through these various APIs is not a limitation of the invention, as any convenient technique may be used. The entitlements discovered in this manner are used to populate the data model 705, as described above and illustrated in FIG. 4.

The entitlement generator module 704 uses the data model 705 to generate application entitlements or organizational entitlements for a given access. As described above, an entitlement generated by the entitlement generator 704 is contextual, and it reflects the responsibilities and relationships a person may have and their assigned privileges within or across a loosely-coupled enterprise environment. The entitlement generator 704 (operated as an organizational entitlement modeling tool) may be used to define an organizational entitlement, which is typically achieved through a logical grouping of identities based on given criteria, such as job titles, job codes, or other organizational criteria. As described generally above, the entitlement generator 704 (operated as an application entitlement modeling tool) may be used to define an application privilege that reflects a set of privileges for a given application. Preferably, the entitlement generator 704 uses one or more policies or rules (together with identity attributes) to facilitate defining the set of control specifications that comprise the entitlements.

Thus, according to the techniques described herein, discovery adapters (which may be implemented in software executed on one or more data processors) obtain data about identity, attributes, permissions, etc. from various systems and applications. If necessary, the framework then normalizes this data to a data model. In this way, even if various enterprise systems have different ways of storing the information, the data is normalized into a unified view within the data model. Thus, for example, a UNIX system access control list (ACL) format might differ from how a database management system stores ACLs, which in both cases also might differ from the manner in which application servers with their security configuration may do so. Likewise, a relationship between a user and another user may be differ depending on the type of system involved. These differences, however, are addressed by the abstract data model, which provides a way to discover relationships, navigate associated attributes, and thus obtain desired information. Any service (e.g., an information retrieval system) that acts as a front end to the data model can then render (or return information about) those relationships, attributes and the like, in response to queries, and without necessarily exposing where the original source information (that was used to populate the data model) was obtained.

Once the data model is formed and the framework has an appropriate view of users and their existing permissions, the discovery module 702 can identify patterns of identities (e.g., users) who may then be clustered (i.e. grouped) together, e.g., because they have similar permissions (such as permission to access a patient database) or similar attributes (such as location=NewYork). Such a grouping may then be considered a role (e.g., doctor role) with given qualifications (e.g., specialty=cardiology) or with given attributes (e.g., location=NewYork). In this way, groups of users and their associated attributes may become the basis of a new entitlement built by the entitlement generator 704.

Preferably, the discovery module 702 has federated access to other systems so that it can obtain information (e.g., patient information) from other systems (multiple county hospitals) within the federated operating environment. In this case, the discovery module has an identity under which it logs into or otherwise accesses the target environments (using its federated identity) so that it can obtain a see a holistic view of the desired patient information. Thus, in one embodiment, at least some of the information used to populate the data model is obtained by the discovery module from across a federation and then coalesced to a unified view (using the abstract data model) so that meaningful analysis can then be done on the data by the entitlement generator module. The discovery and modeling produces a set of one or more entitlements (or, more generally, a policy) that can then be applied by a decision engine that decides whether a user can access a resource based on those entitlements (and, optionally, based on data about what information is available during the access). The decision engine, which is not an aspect of this disclosure, may be implemented in any convenient manner using known systems and technologies.

Without limitation, and as noted above, the discovery and entitlement generator modules may be implemented in software, as one or more specialized or “particular” machines. The discovery and entitlement generator modules, together with the data model may be implemented in a specialized or “particular” machine, such as an entitlements server. The desired associations can be defined through a user interface 707 that includes appropriate utilities and data structures by which the data model is visualized and the entitlements are provisioned. Conventional identity management tools and systems, such as IBM® Tivoli Identity Manager (TIM), may be adapted for this purpose, or the techniques may be implemented in any other convenient manner. As noted above, the discovery framework generates the data model for storing information concerning user identity, context, relationships between users, relationships between users and contexts and relationships between contexts. Preferably, the user identity, context, relationships between users, relationships between users and contexts, and relationships between contexts, are stored as attributes in the data model. The entitlement generator generates a user entitlement according to the data model, wherein the entitlement is generated according to one or more contexts. The user entitlement may be generated according to a role, a relationship of a role to a context, a relationship between a user and another user, or the like.

Generalizing, entitlements are a set of control specifications (rendered through policies) that govern an identity's access to information, application and systems, where a user is one such identity. The above-described data modeling and approach to generating entitlements may be used in a distributed environment across companies, organizations, countries, and so forth. The disclosed modeling and discovery framework spans “contexts” and allows for entitlements, roles and identities to be context-based and thus to span contexts.

The following are examples of the disclosed technique within the context of a federated environment. In one data model, a role called FinancialAdvisor-at-BankA can access FinancialRecords-at-BankB if Bank B allows for the Bank A “context” to be trusted; based on such a trust paradigm existing (as implemented within a federated environment and as evidenced by the data model), appropriate entitlements are defined by the entitlement generator so that a permitted Financial Advisor at Bank A can access the desired application at Bank B. In another example, assume that the data model associates “PersonA-from-Austin” to “Raleigh-utility-bills-housing-tax for PersonB-from-Raleigh” for a given time period (e.g., a “for-2-years-until-2010” attribute (while PersonB is out of the country) is

PersonA also is a ‘trusted-friend’ of PersonB. In this example, the entitlement/resources are also context based (Raleigh=context), and they allows for an identity (PersonA from Austin) to access them within a set of constraints (for 2 years). Moreover, in the second example, the roles span contexts, as the role of trusted-friend is defined by PersonB but could span identities across contexts, and this “relationship” (between Person A and Person B) is captured an attribute called “trusted friend.” In general, the entitlement generator creates an entitlement (“what a user can do”), and the particular entitlement is not a limitation of the invention. Of course, the entitlement will vary depending on the particular system, application or resource involved. Thus, entitlements may be quite varied, e.g., “Joe can approve Bob's expense-reports” (where it is Joe's entitlement to approve an ‘expense reports’ resource, but limited to his employees, like Bob); “Tony can access his wireless account from AT&T website” (this is Tony's entitlement given by AT&T); “Tony can access all IBM employee web sites”; or “Alice can make a phone call to Charlie in social context in Austin,” and so forth.

As these latter examples illustrate, such entitlements may be simple/direct entitlements (e.g., Tony can access a file in a file system through his name or through a group to which he belongs), role-based entitlements (e.g., all ‘employees in IBM can access w3”, managers can approve expense reports), rule-based entitlements (e.g.. only an employee's manager can approve his expense report, only during business hours, etc), attribute-based entitlements (e.g., PCPs with ‘location=NewYork’ can treat patients whose homeState=“NewYork”) and the like. The disclosed data modeling framework relates identity management, role management, and entitlement management all under a consistent framework. In particular, the data model links people to resources, across contexts and through relationships to allow for entitlement definitions to be generated and managed in a simple, extensible manner.

The subject technique is especially advantageous when the subject (the entity that desires access) and resource (that will be accessed) belong to different security domains, as is the case in a federated environment.

The data model is adapted to be stored in a data store, such as a computer memory or persistent data storage. Portions of the data model may be stored in distributed data stores across a federated environment.

The disclosed subject matter provides several advantages. The disclosure provides for a unique abstract data model that is focused on entitlement management (e g , linking people to resources, across contexts and through relationships, and based on policies and rules) that allows for variety of these entitlement definitions to be managed. Existing data models in security do not allow for this flexibility, as they are either role-based, ACL-based, or the like. In the evolving complexity of enterprise policies and security controls, such prior art techniques are insufficient.

The block diagrams in the different depicted embodiments illustrate the architecture, functionality, and operation of some possible implementations of apparatus, methods and computer program products. In this regard, each block in the flowchart or block diagrams may represent a module, segment, or portion of code, which comprises one or more executable instructions for implementing the specified function or functions. In some alternative implementations, the function or functions noted in the block may occur out of the order noted in the figures. For example, in some cases, two blocks shown in succession may be executed substantially concurrently, or the blocks may sometimes be executed in the reverse order, depending upon the functionality involved.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

The invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain or store the program for use by or in connection with the instruction execution system, apparatus, or device.

The medium is tangible, and it can be an electronic, magnetic, optical, electromagnetic, infrared, or semiconductor system (or apparatus or device). Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described to best explain the principles of the invention, the practical application, and to enable others of ordinary skill in the art to understand the invention for various embodiments with various modifications as are suited to the particular use contemplated.

As noted, the entitlement discovery and modeling framework described herein may be implemented in or in conjunction with various server-side architectures including simple n-tier architectures, web portals, federated systems, and the like.

The entitlement discovery and modeling framework described herein may be implemented as a service, or as a standalone machine.

Having described our invention, what we now claim is as follows.

1. A method for discovery, modeling and managing entitlements that provide access to information, applications and systems in a loosely-coupled distributed environment, comprising:
generating, and storing, by an entitlements server, a data model that associates one or more identities to an entity, wherein each identity in the data model has an associated set of characteristics that represent a view of the entity within a context, and wherein a context is a logical scope within which information about an identity and described in the data model is applicable; and
generating, by the entitlements server and using the data model, at least one entitlement, wherein the entitlement governs an identity's access to information, applications and systems.

2. The method as described in claim 1 wherein the loosely-coupled environment is a federated environment.

3. The method as described in claim 1 wherein the step of generating the data model includes discovering a set of entitlements.

4. The method as described in claim 3 wherein the set of entitlements include application entitlements or organization entitlements.

5. The method as described in claim 1 wherein the at least one entitlement is associated with a cluster of users and their associated attributes.

6. The method as described in claim 1 wherein the entitlement generator generates the entitlement using at least one policy.

7. The method as described in claim 6 wherein the entitlement is based on a relationship between first and second entities within or across the context.

8. The method as described in claim 1 wherein the data model data stores information concerning user identity, context, identity attributes, relationships between entities, relationships between users and contexts, and relationships between contexts.

9. Apparatus, comprising:
a processor;
computer memory holding computer instructions that, when executed by the processor, perform a method comprising:
generating and storing in the computer memory a data model that associates one or more identities to an entity, wherein each identity in the data model has an associated set of characteristics that represent a view of the entity within a context; and
using the data model to manage entitlements, wherein an entitlement governs an identity's access to information, applications and systems across a loosely-coupled distributed computing environment.

10. The apparatus as described in claim 9 wherein the step of generating a data model includes data model stores information concerning user identity, context, relationships between entities, relationships between users and contexts, and relationships between contexts.

11. The apparatus as described in claim 9 wherein the data model associates entities to resources across contexts within the loosely-coupled distributed computing environment.

12. The apparatus as described in claim 11 wherein the distributed computing environment is a federated environment.

13. An entitlement framework apparatus, comprising:
a processor;
computer memory associated with the processor;
a data model stored in computer memory, the data model storing information concerning user identity, context, identity attributes, relationships between users, relationships between users and contexts, relationship between identities and resources, and relationships between contexts; and
an entitlement generator executed by the processor as a set of computer instructions, the entitlement generator generating a user entitlement according to the data model, wherein the user entitlement is generated according to one of a plurality of contexts.

14. The entitlement framework apparatus as described in claim 1 wherein the user entitlement is generated according to a role, identity attributes, a relationship of the role to a context, a relationship between a user and at least one other user, a relationship between a user and a resource, or relationship between the context and at least one other context.

15. A computer program product in a computer readable medium for use in a data processing system for entitlement management and processing, the computer program product holding computer program instructions which when executed by the data processing system perform a method comprising:
generating and storing a data model that associates one or more identities to an entity, wherein each identity in the data model has an associated set of characteristics that represent a view of the entity within a context; and
using the data model to generate at least one entitlement, wherein the entitlement governs an identity's access to information, applications and systems.

16. The computer program product as described in claim 15, wherein the identity's access to information, applications and systems occurs across a federated environment.

17. The computer program product as described in claim 15, wherein the computer program instructions are stored in the computer readable medium in the data processing system, wherein the computer program instructions were downloaded over a network from a remote data processing system.

18. The computer program product as described in claim 15, wherein the computer program instructions are stored in the computer readable medium in the data processing system, wherein the computer program instructions are downloaded over a network to a remote data processing system for use in a computer readable medium with the remote system.
